(19) United States
(12) Patent Application Publication
(10) Pub. No.: US 2018/0096552 A1
(43) Pub. Date: Apr. 5, 2018

(54) CLOUD-BASED CONNECTIVITY TOOL AND METHOD

(71) Applicant: PollMole Corporation, Clearwater, FL (US)

(72) Inventors: Richard C. Davis, Clearwater, FL (US); Lior Sher, Clearwater, FL (US)

(21) Appl. No.: 15/714,600

(22) Filed: Sep. 25, 2017

Related U.S. Application Data
(60) Provisional application No. 62/399,916, filed on Sep. 26, 2016.

(51) Int. Cl. G07C 13/00; G06Q 30/02

(52) U.S. Cl. CPC G07C 13/00; H04L 63/08; G06Q 30/0203

(57) ABSTRACT

A method for conducting a survey or poll includes receiving authentication data from a plurality of users. The received authentication data is evaluated for each user to determine if the authentication data is valid. In response to determining that the authentication data is valid for a particular user, that user is provided access to a plurality of voting options. Voting information is received from at least some of the plurality of users. The received voting information identifying selected one of the plurality of voting options is analyzed in real time. Voting results are presented to at least some of the plurality of users based on the analyzed voting information.

### CROSS REFERENCE TO RELATED APPLICATION

This application claims priority to and the benefit of, pursuant to 35 U.S.C. § 119(e), U.S. provisional patent application Ser. No. 62/399,916, filed Sep. 26, 2016, entitled “INTERNET-BASED CONNECTIVITY TOOL AND METHOD,” which is incorporated herein in its entirety by reference.

### FIELD

The present disclosure relates generally to online polling and voting, and more particularly to cloud-based connectivity tool and method.

### BACKGROUND

Surveys, polls, discussion groups, and other forms of seeking user responses are commonly used for collecting information about products, services, opinions, etc. Such information may be of interest to political candidates, marketing personnel, product developers, service providers, or employers, among others. Unfortunately, conventional forms of presenting surveys, polls, questionnaires, or other ways of obtaining user responses suffer from a number of significant limitations. For example, present internet-based polling and survey technologies may be missing an ability to provide for one or more of acquiring market research or polling information for an unlimited dataset, a digital interface, user convenience, continuous analytics, real-time data gathering, high statistical confidence, low margin of error, flexibility in market queries, low data acquisition costs, inexpensive customer costs, or all of the above.

Thus, there is a need in the art for a system capable of overcoming one or more of the above-mentioned deficiencies.

### SUMMARY

Certain aspects of the present disclosure relate to a web application for automatic online polling and voting.

In accordance with a purpose of the illustrated embodiments, in one aspect, a method for conducting a survey or poll includes receiving authentication data from a plurality of users. The received authentication data is evaluated for each user to determine if the authentication data is valid. In response to determining that the authentication data is valid for a particular user, that user is provided access to a plurality of voting options. Voting information is received from at least some of the plurality of users. The received voting information identifying selected one of the plurality of voting options is analyzed in real time. Voting results are presented to at least some of the plurality of users based on the analyzed voting information.

Certain aspects of the present disclosure relate to a non-transitory computer readable medium storing computer executable code. In certain embodiments, the computer executable code, when executed at a processor of a computing device, is configured to perform the above described method.

### BRIEF DESCRIPTION OF THE DRAWINGS

The present disclosure will become more fully understood from the detailed description and the accompanying drawings. These accompanying drawings illustrate one or more embodiments of the present disclosure and, together with the written description, serve to explain the principles of the present disclosure. Wherever possible, the same reference numbers are used throughout the drawings to refer to the same or like elements of an embodiment.

FIG. 1A and FIG. 1B are diagrams illustrating elements or components of an example operating environment in which embodiments of the present invention may be implemented.

FIG. 2 schematically shows a workflow of the steps performed by a survey/poll manager, according to certain embodiments of the present disclosure.

FIG. 3, FIG. 4, FIG. 5, FIG. 6, and FIG. 7 are an exemplary series of data collection display screens for presenting the terms and conditions of provided service, collecting notification information and miscellaneous authentication information from a user presented by the survey/poll manager, according to certain embodiments of the present invention.

FIG. 8A and FIG. 8B are exemplary voting display screens presented by the survey/poll manager, according to certain embodiments of the present invention.

FIG. 9, FIG. 10, and FIG. 11 are exemplary voting results screens presented by the survey/poll manager, according to certain embodiments of the present invention.

FIG. 12 shows an exemplary Election Day presidential exit poll home screen presented by the survey/poll manager, according to certain embodiments of the present disclosure.

FIG. 13, FIG. 14A and FIG. 14B are exemplary presidential exit poll voting display screens presented by the survey/poll manager, according to certain embodiments of the present invention.

FIG. 15, FIG. 16, FIG. 17, FIG. 18 and FIG. 19 are exemplary presidential exit poll voting results screens presented by the survey/poll manager, according to certain embodiments of the present invention.

FIG. 20, FIG. 21, FIG. 22 and FIG. 23 are an exemplary series of web-site integration display screens for displaying polling/survey data, according to certain embodiments of the present invention.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

Unless otherwise defined, all technical and scientific terms used herein have the same meaning as commonly understood by one of ordinary skill in the art to which this invention belongs. The terminology used in the description is for describing particular embodiments only and is not intended to be limiting of the invention.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the term “module” may refer to, be part of, or include an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The present disclosure relates to computer systems. As depicted in the drawings, computer components may include physical hardware components, and virtual software components. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present disclosure will now be described more fully hereinafter with reference to the accompanying drawings, in which embodiments of the present disclosure are shown. This disclosure may, however, be embodied in many different forms and should not be construed as limited to the embodiments set forth herein; rather, these embodiments are provided so that this disclosure will be thorough and complete, and will fully convey the scope of the present disclosure to those skilled in the art.

In certain embodiments, the system for automated online polling and voting includes a computing device, such as a web application server that contains a survey/poll manager configured to automate the process of collecting, analyzing and displaying opinions, thoughts and ideas from an inter-connected group of an unlimited number of users within a community. The survey/poll manager, in response to receiving authentication data from users′, is configured to control access to voting options, as well as voting results to a plurality of users.

Certain aspects of the present disclosure relate to a method that allows an originator to broadcast queries to obtain analyzable responses that are organized into customizable numeric and/or graphic-based compilations of community replies that provide the Originator with customizable, selectable reports and/or summaries containing meaningful actionable information. Top line information from each query can be broadcast system-wide as minimally-formatted, streaming raw data, viewable in real-time in numeric and/or graphic-based formats by the entire community of users.

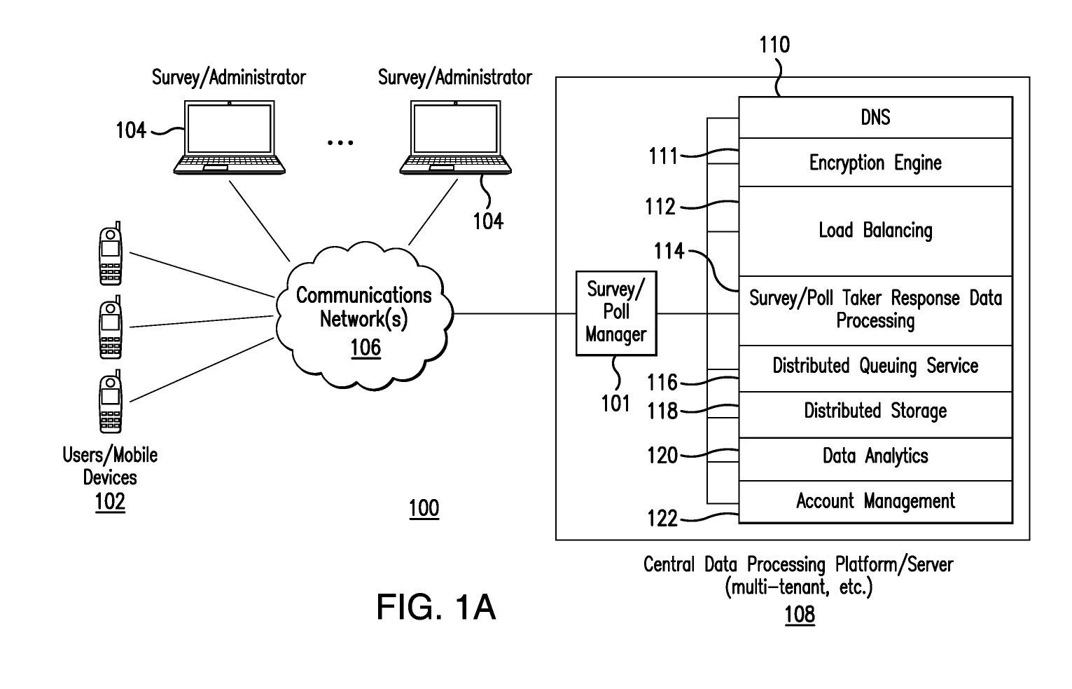

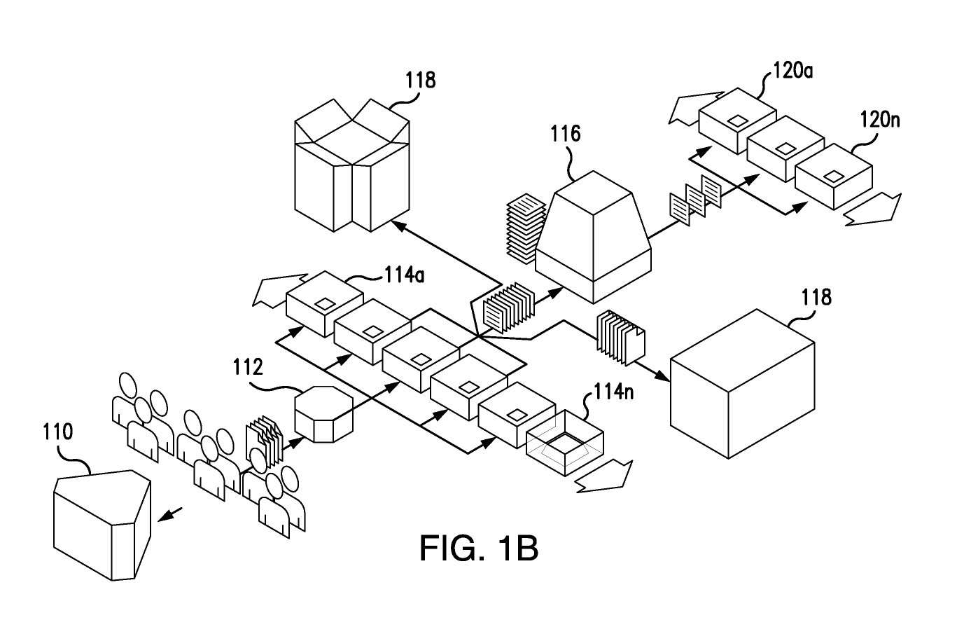

FIG. 1 is a diagram illustrating elements or components of an example operating environment 100 in which an embodiment of the invention may be implemented. As shown, a variety of client processes or modules incorporating and/or incorporated into a variety of computing devices (such as mobile devices 102) may communicate with a data processing/computing platform 108 through one or more networks 106. A survey administrator 104 may also communicate with platform 108 via a suitable network or networks 106, typically by using a desktop computing device or terminal.

For example, a client may incorporate and/or be incorporated into a client application (e.g., software) implemented at least in part by one or more of the computing devices 102. Examples of suitable computing devices include, but are not limited to, tablet computers or personal digital assistants (PDAs), smart phones, cell phones, and consumer electronic devices incorporating one or more computing device components, such as one or more electronic processors, microprocessors, central processing units (CPU), or controllers. Examples of suitable networks 106 include networks utilizing wired and/or wireless communication technologies and networks operating in accordance with any suitable networking and/or communication protocol (e.g., a wireless network coupled to the Internet).

The data processing platform (which in some cases may be a cloud-based data processing platform) 108 may include multiple processing tiers or functional modules. These tiers or modules operate to provide each user account (which may be associated with one or more survey or poll makers) with tools to participate in and/or evaluate the results of their respective survey or poll. Generally, each survey taker (or set of takers, such as those employed by a single entity/tenant) will be associated with an account maintained on platform 108. Tenant Account Management module 122 functions to permit a user to register for an account, including providing a username or account name and authentication data (such as a password). Account Management module 122 may also be responsible for receiving and processing user credentials (such as username and password) to authenticate a user and permit access to data and information on platform 108. One or more of the services (such as data processing applications, data storage, etc.) resident on or accessible via platform 108 may be provided to tenant users as a cloud-based web-service or a form of Software-as-a-Service (SaaS).

Other elements or processes that may be resident on platform 108 and available to tenant users, may include but are not limited to (or required to include):

Survey/Poll Manager module 101—configured to control various components of the platform 108 to provide survey, questionnaire or poll to users, obtain user(s) response data, process user response data and provide processed results substantially in real-time to a plurality of users;

Domain Name System (DNS) 110—may used for translating domain names into IP addresses and is an essential part of the data processing infrastructure 108;

Encryption Engine 111—can employ various 4th generation encryption techniques known in the art;

Load Balancing Engine 112—for balancing received voting data between a plurality of data processing web servers 114a-114n within the data processing platform 108.

Survey/Poll Taker Response Data Processing 114—these elements or processes hosted, for example, by a plurality of web servers may include functions, operations, models, applications, or other forms of mathematical/statistical processes that may be used to pre-process, analyze and evaluate the responses received from survey takers from their respective mobile devices 102 over network(s) 106—typically, these may be selected by the administrator to assist in understanding the survey or poll results from a specific survey or set of survey takers, but may also be recommended by platform 108 (such as by the Data Analytics processes 120) based on characteristics of the survey, the devices, the survey takers, etc. Such functions, operations, models, applications, or other forms of mathematical/statistical processes may include machine learning, statistical analysis, clustering algorithms, pattern matching, etc.;

Distributed Queueing Service 116—enables the survey/poll manager to store and retrieve elements of queues, with the queue elements able to store a variety of types of data in various embodiments;

Distributed Storage System 118—large scale storage system that enables the survey/pole manager module quickly and efficiently store and retrieve large amounts of data, while having low storage overhead;

Data Analytics 120—these elements or processes may include functions, operations, models, or other forms of mathematical/statistical processes that may be used to analyze and evaluate the response data and/or metadata received from multiple survey takers and/or accounts in order to generate insights into the response data; and

Account Management module 122—may be responsible for receiving and processing user credentials.

Note that the survey/poll manager 101 may interact with platform 108 to create, generate, or author a survey/poll, distribute the survey/poll to a desired set of survey/poll takers/mobile devices 102, manage the processing of the survey/poll responses, analyze or evaluate the survey/poll results alone or in aggregate, and determine how to present those results through interactions with the various functions or processes available on platform 108. In some cases, results may be presented to mobile devices 102 via a dashboard or other graphic and/or textual format.

Each distributed storage element may contain user-specific data (device user response data, device user metadata, user account information, etc.). Data storage components may be implemented with any suitable data storage technology, including structured query language (SQL) based relational database management systems (RDBMS).

By means of a cloud-based data processing platform or other form of “web-service” platform, a survey maker or group of survey makers may utilize systems and processes provided by a third party. Such a third party may implement an integrated system/platform as described above in the context of a cloud-based platform, wherein individual instantiations of a single comprehensive integrated set of applications are provided to a variety of tenants utilizing the cloud-based platform. One advantage to such multi-tenant platforms may be the ability for each tenant to customize their instantiation of the system and processes to that tenant's specific business needs or operational methods. For example, each tenant may be a business or entity that uses the cloud-based platform to provide surveys, polls, or other forms of interactions and functionality to multiple users (such as employees, survey takers, or customers).

In general, an embodiment of the invention may be implemented using a set of software instructions that are designed to be executed by a suitably programmed processing element (such as a CPU, microprocessor, processor, controller, computing device, etc.). In a complex system such instructions are typically arranged into “modules” with each such module performing a specific task, process, method, function, or operation. The entire set of modules may be controlled or coordinated in their operation by an operating system (OS) or other form of organizational platform.

Each user interface may include one or more interface elements. For example, users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols.

The platform's application or functional modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

Note that the example computing environment depicted in FIG. 1 is not intended to be a limiting example. Alternatively, or in addition, computing environments in which an embodiment of the invention may be implemented include any suitable system that permits users (such as survey/poll makers or takers) to provide data to, and access, process, and utilize data stored in a data storage element (e.g., a database) that can be accessed remotely over a network. Further, example environments in which an embodiment (or an aspect of an embodiment) of the invention may be implemented include devices (including mobile devices), software applications, systems, apparatuses, networks, or other configurable components that may be used by multiple users for data entry, data processing, application execution, data review, etc. and which have user interfaces or user interface components that can be configured to present an interface to a user. Although further examples may reference the example computing environment depicted in FIG. 1, it will be apparent to one of skill in the art that the examples may be adapted for alternate computing devices, systems, apparatuses, processes, and environments. Note that an embodiment of the inventive methods may be implemented at least partially in the form of an application, a sub-routine that is part of a larger application, a browser, a “plug-in”, an extension to the functionality of a data processing system or platform, or other suitable form.

This application includes information describing examples and/or details regarding one or more embodiments of the inventive system and methods described herein. Specifically, examples of displays and user interface elements that may be used as part of a survey or poll, and that would be presented to a survey user on their mobile device are described and illustrated. The use cases described represent examples of the types of survey or poll questions that may be asked of a survey taker, and of a manner in which such a survey or poll may be implemented on a survey taker's mobile device. They are not meant to be exhaustive or restrictive, but only to present examples of how certain features or aspects of the inventive system and methods may be implemented.

FIG. 1B is a more detailed diagram illustrating elements or components of the data processing platform 108.

In one embodiment, the platform 108 includes a DNS server 110. DNS server 110 can comprise a shared DNS server that serves multiple networks. The shared DNS server 110 can be provisioned and maintained with independent operation for each associated network. The DNS server 110 can comprise one or more storage devices (memories) and one or more processors in communication with one another. The DNS server 110 may be a DNS server capable of providing ability to perform name resolution for customer hosted domains, while providing tenant isolation during name resolution.

In one embodiment the load balancing engine 112 may be implemented as an elastic load balancer. In this embodiment, the elastic load balancer 112 is used for the load balancing tier to distribute traffic across the multiple instances of data processing web servers 114. This enables the platform 108 to seamlessly manage the amount of load to respond to incoming data traffic. Such a setup can also help detect the health of underlying Web and App instances including their CPU and network usage. Upon detection of a failure in any of the web server instances 114, the setup allows the routing of requests to “healthy” or working instances. Using elastic load balancing also increases the flexibility in modifying the network. For instance, elastic load balancing allows scaling of the network by adding or removing resources or instances as required, and this helps to avoid/reduce the downtime of the platform 108. The survey/poll taker response data processing may be performed by an elastic cloud webserver farm 114a-114n, in accordance with one embodiment. The processes hosted by a plurality of web servers 114a-114n may include functions, operations, models, applications, or other forms of mathematical/statistical processes that may be used to pre-process, analyze and evaluate the responses received from survey takers from their respective mobile devices 102 over network(s) 106.

More specifically, in an embodiment, the compute processing webservers 114 are implemented using Amazon's “Elastic Compute Cloud” (EC2) resources. The EC2 is a web service that provides resizable compute capacity in a cloud-based network that can be scaled to provide computing capacity for applications serving multiple client devices. In this same embodiment, the database servers 118 are implemented using Amazon's “Simple Storage Service” (S3) which provides a data storage capacity be used to store and retrieve any amount of data, at any time, from anywhere on the Internet. In this embodiment, the Database management system (DBMS) may incorporate data architectures, such as Teradata. Essentially, Teradata is a parallel architecture used to efficiently store, retrieve, and process large volumes of data. Likewise, in the same embodiment, the Distributed Queueing Service 116 is implemented using Amazon's “Simple Queue Service” (SQS) which provides a hosted queue for storing messages and data as they are passed between different distributed components of the platform 108. In this embodiment, the SQS is used to pass data between executing processes on the Survey/Poll Taker Response Data Processing webservers 114 and the Data Analytics servers 120.

In one embodiment, data analytics servers 120 can be implemented using big data analytics platforms such as Amazon™ Web Service technology. Amazon™ Web Service technology and similar systems usually materialize intermediate results (referred to as “opportunistic views”) of a query plan for fault tolerance, which can be reused to speed up future queries. Thus to minimize the total cost of a sequence of queries, each query does not simply use the currently cheapest, but considers whether a plan will produce useful opportunistic views that may benefit future queries.

In addition, the encryption engine 111 (not shown in FIG. 1B) may be implemented to provide a form of ultra-secure, system-wide encryption like the BlackRidge® Transport Access Control (TAC). TAC provides a mechanism to authenticate a network connected device on the first packet of a TCP session request. The authentication mechanism uses various fields in the IP and TCP headers in the TCP connection request. All of these fields have a primary function that is defined in the IP and TCP specifications. The use of existing fields to pass an authorization key is necessary because the TCP protocol specification does not provide a mechanism to pass user data on a TCP connection request.

TAC provides an authentication mechanism that functions using only the fields in the IP and TCP headers that are normally present in the TCP connection establishment request. Within the IP and TCP headers there are fields that have strictly defined meanings that do not allow any additional encoding because this would alter the functionality of the IP and/or TCP protocols. Examples of such fields are the Source Address, Destination Address, Checksum, Source Port and Destination Port fields. Advantageously, the encryption engine 111 protects data and network applications (i.e., the survey/poll manager 101) by concealing network applications from port scans, network reconnaissance, and intrusion, while allowing authenticated users to access the data processing platform 108 normally.

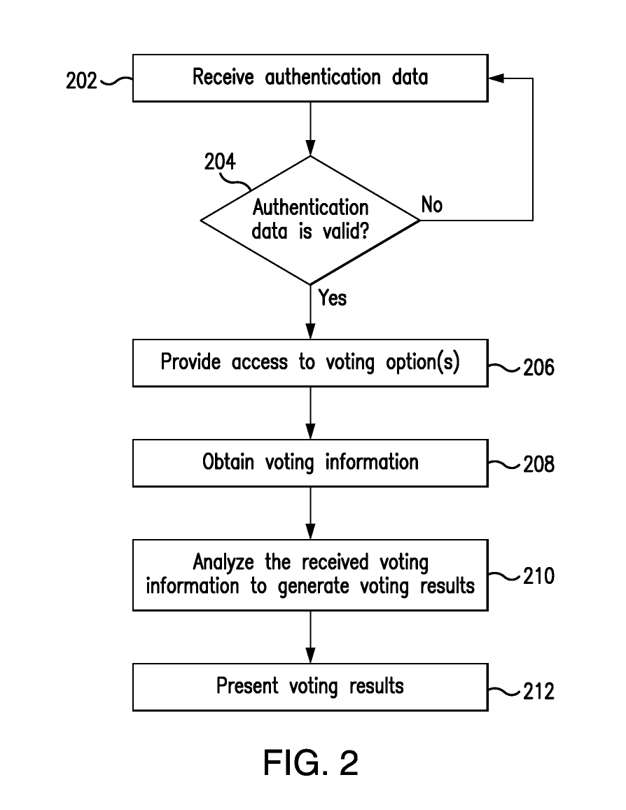

Before turning to description of FIG. 2, it is noted that the flow diagram shown therein is described, by way of example, with reference to components shown in FIGS. 1A-1B, although these operational steps may be carried out in any system and are not limited to the scenario shown in the aforementioned figure. Additionally, the flow diagram in FIG. 2 illustrates an example in which operational steps are carried out in a particular order, as indicated by the lines connecting the blocks, but the various steps shown in this diagram can be performed in any order, or in any combination or sub-combination. It should be appreciated that in some embodiments some of the steps described below may be combined into a single step. In some embodiments, one or more additional steps may be included.

As shown in FIG. 2, at step 202, the survey/poll manager 101 starts the method by receiving user login information/authentication data (e.g., user name/password) from a cross-platform downloadable User Interface (UI) application running on mobile device(s) 102. At least in some embodiments, the authentication data may include user's device information captured by the application running on the user devices in order to prevent multiple sign ups and and multiple sign on's and voting. Such authentication data may include, but is not limited to service provider identification, device model identification, device identification, international mobile equipment identity (IMEI), Integrated Circuit Card Identifier (ICCID).

At step 204, the survey/poll manager 101 in concert with the account management component 122 evaluates the login information/authentication data to determine the voting/survey options and/or results information, if any, that may be accessed by users attempting to login. In this step, the survey/poll manager 101 may also determine whether any of the users have voted already.

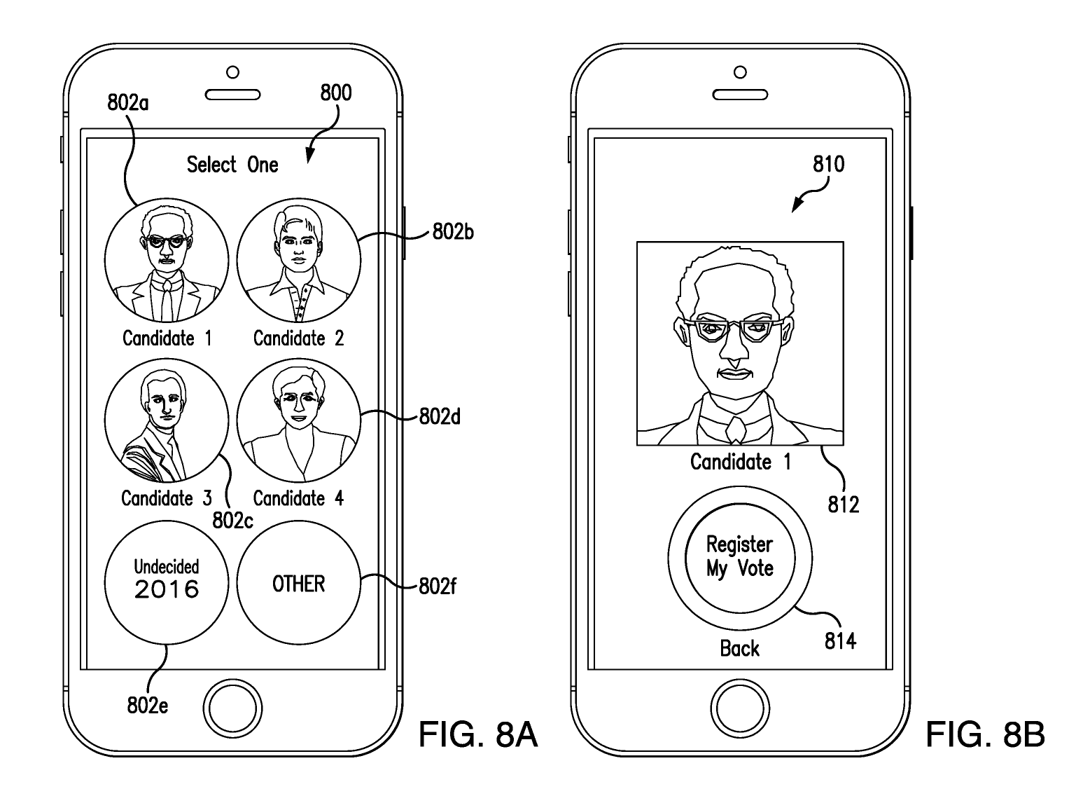

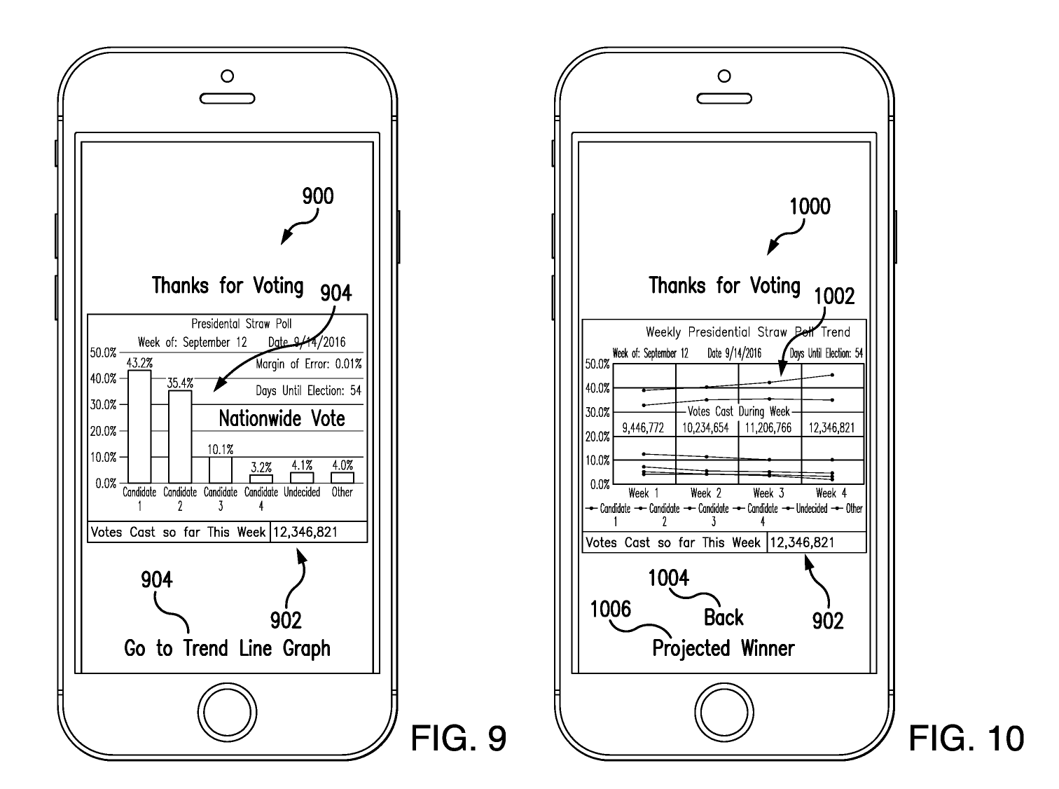

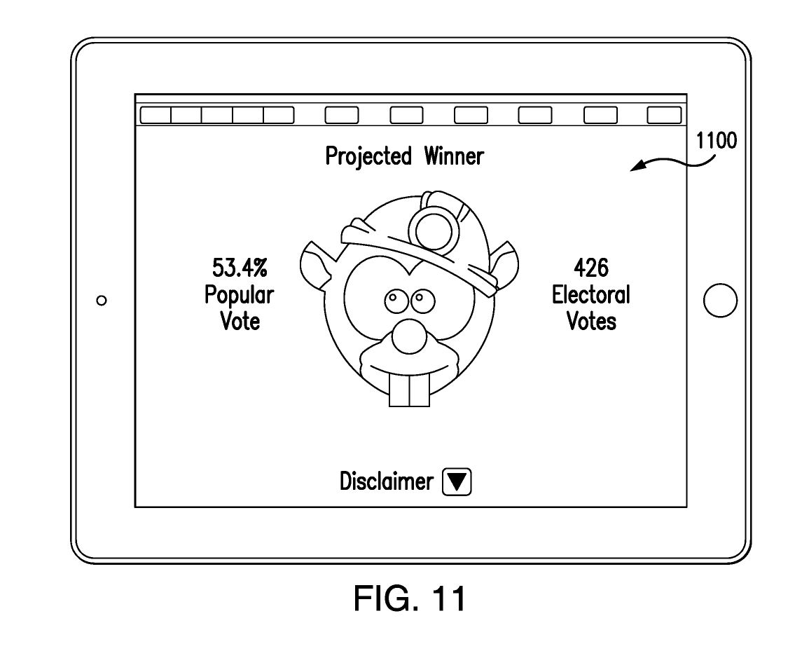

After that, in response to determining that both user login information and authentication data are valid, the survey/poll manager 101 performs a cycle of steps 206 to 212. In the cycle, at step 206, the survey/poll manager 101 determines user-specific voting/survey options. This step may further involve presenting user-specific voting/survey options to users by displaying one of the voting screens (e.g., the voting screen shown in FIG. 8A and described in greater detail below) with user-specific options on users' mobile devices 102.

At step 208, the survey/poll manager 101 obtains voting information of voting eligible users, for example, via the screen shown in FIG. 8B. At step 210, the survey/poll manager 101 analyzes the received voting information to generate voting results in real time. When the UI on the device 102 sends the casted vote data to the survey/poll manager 101, the casted vote data may include a vote choice. The survey/poll manager 101 may analyze the received data from the plurality of users and determine from the indication how to tally the votes. In addition to tallying the votes, the survey/poll manager 101 may analyze voting trends and/or project a winner based on accumulated data, as described below in conjunction with FIGS. 9-11 and 15-18.

At step 212, the survey/poll manager 101 presents user-specific voting/survey results to users via the UI on the mobile devices 102. Advantageously, the survey/poll manager 101 may be configured to stream raw data results in easy-to-understand numeric and/or graphic formats. More specifically, the survey/poll manager 101 is configured to broadcast streaming results of responses to various surveys/polls to the entire community of users as raw data organized as numeric or graphic representations in real time or near real time.

By the above process shown in FIG. 2, the system disclosed herein is configured to enable querying (i.e., polling) of an unlimited audience of users in real time in order to canvas enormous sample sizes of responders thus significantly reducing polling margins of error. Without intending to be limiting, applications of the system and method of the present invention include conducting: a) Political Polls; b) Market Research, and c) Public Opinion Polls.

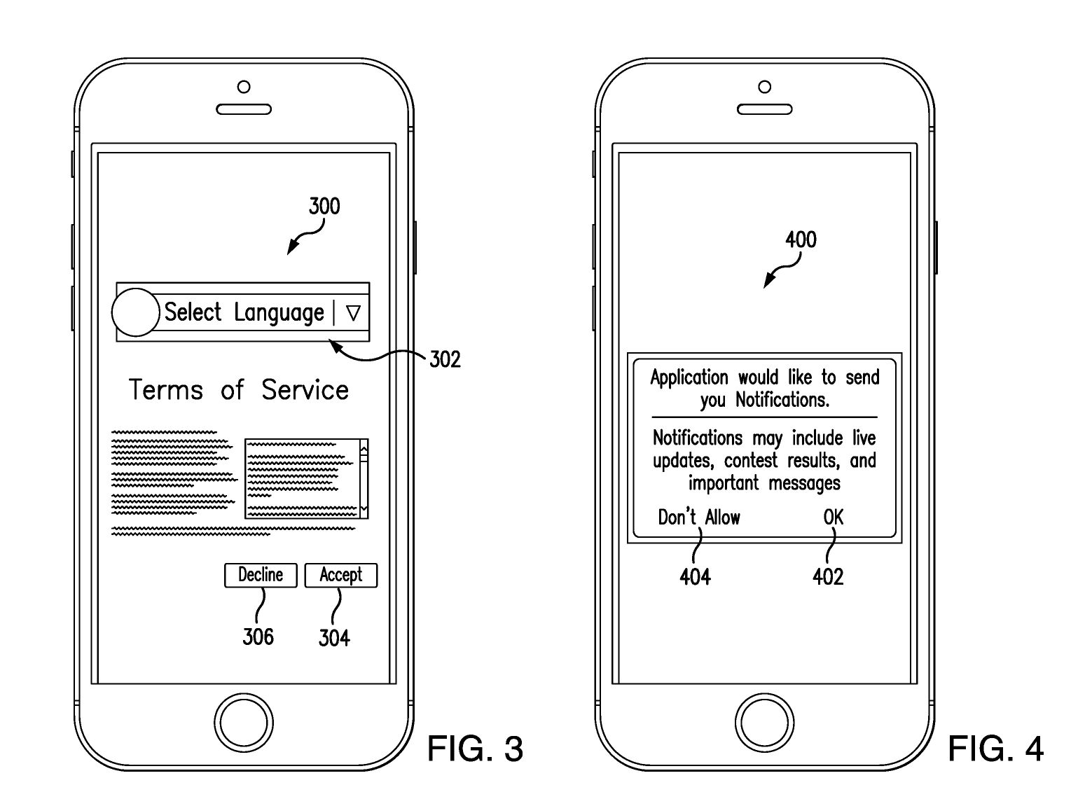

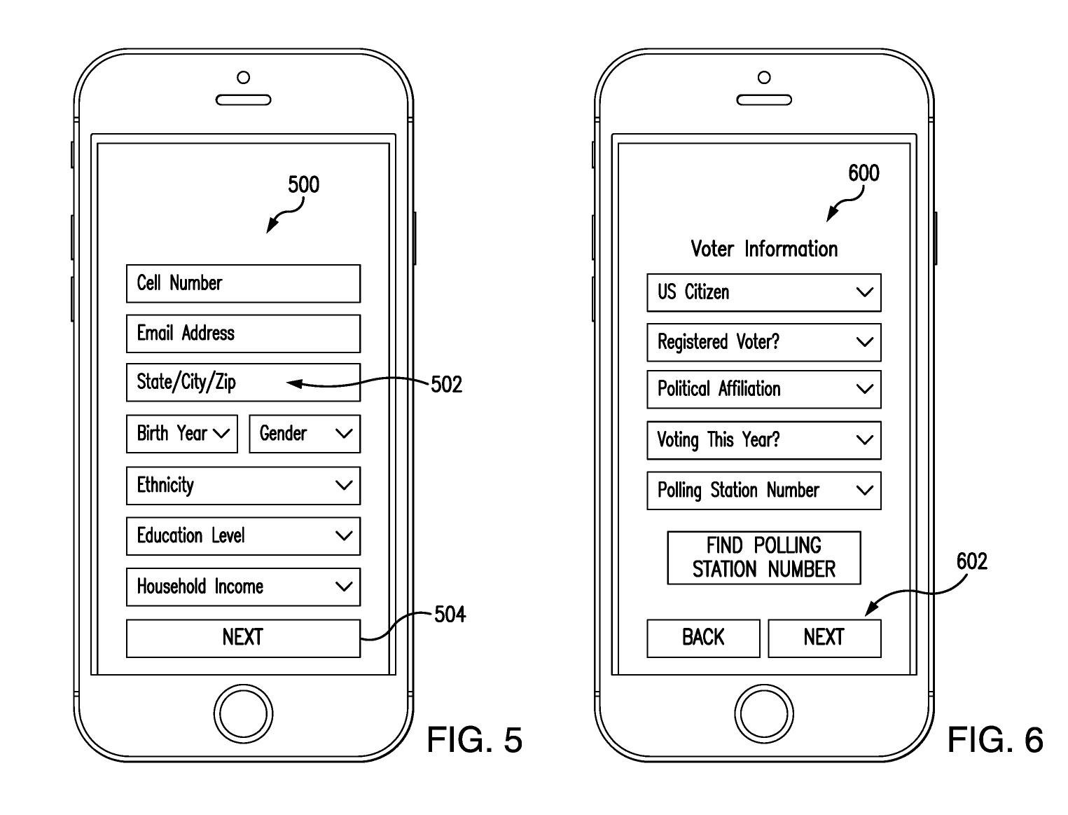

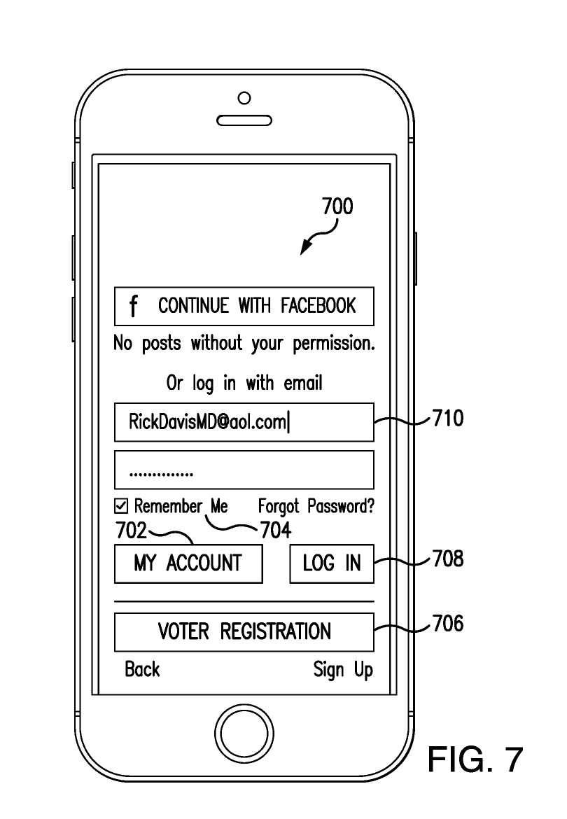

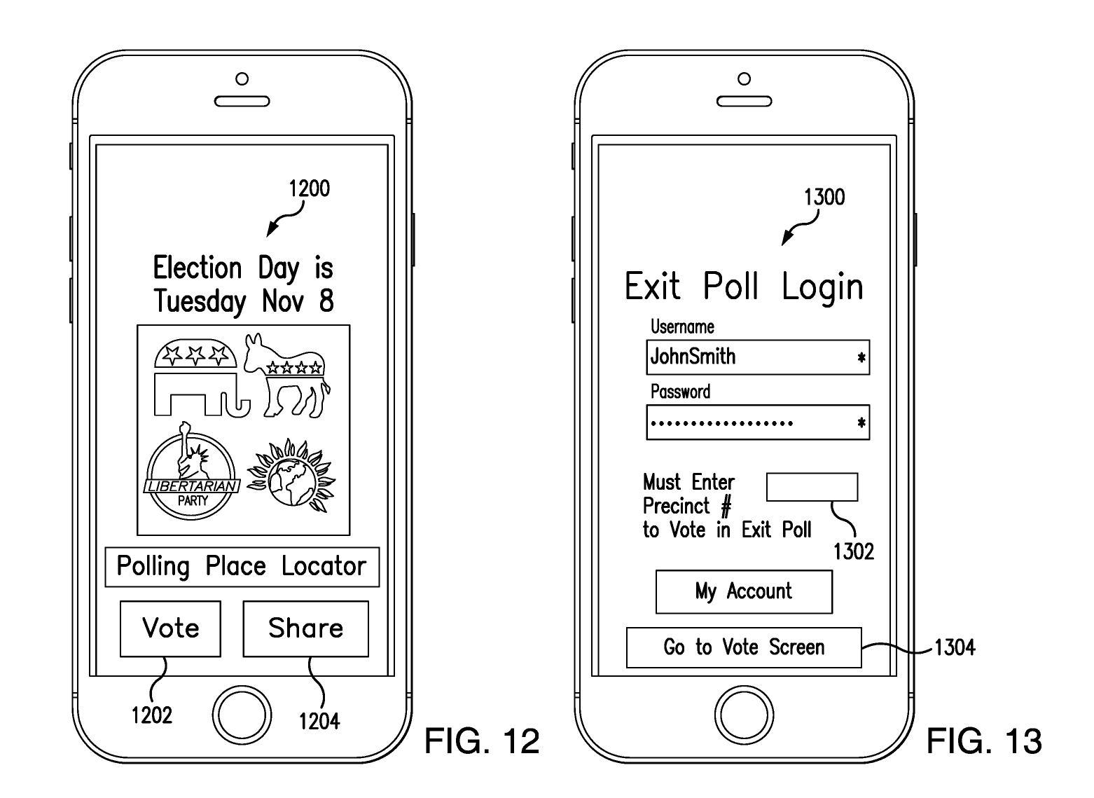

FIGS. 3-11 are screenshots presented by the survey/poll manager 101 via the voting UI that allows the user to choose from presented voting options according to an exemplary embodiment illustrating a nationwide Weekly Straw Poll, and FIGS. 12-19 are screenshots presented by the survey/poll manager 101 illustrating a nationwide Election Day exit poll, in accordance with another exemplary embodiment. While the example screenshots of FIGS. 3-23 are presented in English, the UI may be displayed in any language.

FIG. 3 illustrates a screen 300 that may be an initial screen of terms of service that may be displayed when the application is launched for a first time for a user or upon user request. The “Terms of Service” screen 300 may include an option 302 to choose a display language from among all available languages in the system. The survey/poll manager 101 saves the language preference. This screen 300 is shown to a user prior to signup page only if this is the first visit. As shown, the “Terms of Service” screen 300 may show information about the terms of service and may contain an “Accept” button 304 for accepting the terms of service and a “Decline” button 306 for declining the terms of service. When the user selects the “Accept” button 304 on the “Terms of Service” screen 300, acceptance information indicating that the user has accepted the terms of service may be transmitted to the survey/poll manager 101 from the mobile device 102. When the survey/poll manager 101 receives the acceptance information from the device 102, it may cause the UI to display a “Notification” screen 400 next. In case the user selects the “Decline” button 306, then the UI of the voting application is configured to terminate the process and close down.

The “Notification” screen 400, as shown in FIG. 4, may also be shown to a user only on the first visit. As shown, the “Notification” screen 400 may show information about potential notifications and may contain an “OK” button 402 for accepting notifications and a “Don't Allow” button 404 for declining the notifications. If the user selects the “OK” button 402, then the survey/poll manager 101 is configured to take the user to a “Sign-up” screen 500. If the user selects the “Don't Allow” button 404 on the “Notification” screen 400, then the survey/poll manager 101 is configured to generate and push a message to the mobile device 102 indicating that the application cannot update in real time, and that the user will only get snapshot information each time they log in.

According to an embodiment of the present invention, the “Sign-up” screen 500, as shown in FIG. 5, may be yet another screen that appears only on user's first visit and may contain one or more pulldown menus. Some fields that may appear on the “Sign-up” screen 500 are shown in FIG. 5 and may include, for example, State/City/Zip field 502 that should be filled in by users. The information saved by the “Sign-up” screen 500 may be accessed later by users by pressing the “My Account” button 702 on the “Login” screen 700 described below. The “Sign-up” screen may further include a “Next” button 504 for allowing users to proceed to the next step. Failure to complete all required fields, when the “Next” button 504 is selected, as determined by the survey/poll manager 101, will result in the survey/poll manager 101 asking users to complete all missing information. Once the survey/poll manager 101 determines that all required information is complete, in response to user's selection of the “Next” button 504, a “Miscellaneous” screen 600 may be presented next.

FIG. 6 illustrates the “Miscellaneous” screen 600 that appears on users' first visit and may contain one or more pulldown menus to obtain additional user information (e.g., voter information) that may be applied to any poll or market research survey. The information saved by the “Miscellaneous” screen 600 may also be accessed later by users by pressing the “My Account” button 702 on the “Login” screen 700. The “Miscellaneous” screen 600 may further include a “Next” button 602 for allowing users to proceed to the next step. Failure to complete all required fields, when the “Next” button 602 is selected, as determined by the survey/poll manager 101, will result in the survey/poll manager 101 asking users to complete all missing information. Once the survey/poll manager 101 determines that all required information is complete, in response to user's selection of the “Next” button 602, the “Login” screen 700 may be presented next.

In cases in which users' registration and/or authentication is successful, the “Login” screen 700, as illustrated in FIG. 7, for example, is presented. The “Login” screen becomes a home screen for each user after a successful registration. The “Login” screen 700 can include a “Remember Me” option 704. The “Remember Me” option 704 can have a check box where the user can input whether they want an easy password-only access. As noted above, the “My Account” button 702 enables users to edit their account information. The “Login” screen 700 can further include a “Voter Registration” button 706 and a “Log In” button 708. According to an embodiment of the present invention, the “Voter Registration” button 706 may include a link to a website with all information for anyone who wants to vote or register to vote in the USA. If the login input 710 is satisfactory, triggering the “Log In” button 708 grants the user access to the application. If the user gets access to the application then the survey/poll manager 101 next determines if this user voted that week. If the user did not vote that week, triggering the “Log In” button 708 allows users to get to voting options presented by a “Voting” screen 800. If the user did vote that week, triggering the “Log In” button 708 takes users to real time results presented by a “Vote Counter” screen 900. In this case, the survey/poll manager 101 hides the “Voting” screen 800 from users no longer eligible to vote.

FIGS. 8A-8B are exemplary voting display screens presented by the survey/poll manager 101, according to certain embodiments of the present invention. More specifically, the “Voting” screen 800 presents to a user all voting options for a nationwide Weekly Straw Poll. According to an embodiment of the present invention, each user can vote only once in each Weekly Straw Poll. Accordingly, once the survey/poll manager 101 receives user's voting information, responsive to a user casting a vote, the survey/poll manager 101 removes user's access to the “Voting” screen 800 until next week (e.g., midnight Sunday of that week). Once user's access to the “Voting” screen 800 is removed, after logging in to the app, the user is presented with a “Vote Counter” screen 900. According to an embodiment of the present invention, at the beginning of next week (e.g., midnight of next Sunday) the survey/poll manager 101 is configured to reset all counters to zero and to restore users' access to the “Voting” screen 800 for all registered users to provide users an opportunity to participate in a new Weekly Straw Poll. As shown in FIG. 8A, the “Voting” screen 800 presents ballot questions (voting options) 802a-802f to the user if the voting session is authorized based on the received authentication data. In response to receiving interactive voter selection from the user's device, the survey/poll manager 101 presents a “Vote Registration” screen 810 next. According to an embodiment of the present invention, elements of the “Vote Registration” screen 810 may include a bigger picture of the voter's selection 812 and a touch button 814. Responsive to user pressing the touch button 814, the survey/poll manager 101 may tally the vote and may present the “Vote Counter” screen 900 next. The survey/poll manager 101 may also generate a voting confirmation for the user/voter. In various embodiments, the voting confirmation may comprise at least one of an email, a tweet, an SMS message, an MMS message, a Unstructured Supplementary Service Data (USSD) message or a smart TV app generated message. In one embodiment, the confirmation message may read: “Your vote was registered at [date-time stamp] as the XX,XXX, XXX vote in this week's poll. Thank you for supporting the candidate of your choice, and being part of our great American democracy in action! Be sure to vote again next week.”

FIGS. 9-11 are exemplary voting results screens presented by the survey/poll manager 101, according to certain embodiments of the present invention. In an embodiment, the “Vote Counter” screen 900 may include a vote counter ticker 902 and a chart 904. The vote counter ticker 902 may comprise a running count of the casted votes. The chart 904 may comprise a bar chart that is updated in real time with changing vote tallies. In addition, the “Vote Counter” screen 900 may include a link 904 to a “Trend Line” screen 1000. In an embodiment, the “Trend Line” screen 1000 may include the vote counter ticker 902 and a chart 1002. In this case, the chart 1002 may comprise a line graph that is updated in real time with changing vote tallies. In addition, the “Trend Line” screen 1000 may include two links 1004 and 1006. By selecting the “Back” link 1004 the user can navigate back to the “Vote Counter” screen 900. In response to user's selection of the “Projected Winner” link 1006, the survey/poll manager 101 presents a “Projected Winner” screen 1100. According to an embodiment of the present invention, the survey/poll manager 101 presents prediction results via the “Projected Winner” screen 1100. For example, the prediction results may include a projected winner determined by the survey/poll manager 101 based upon analysis of the vote tallies in each state.

FIG. 12 shows an exemplary “Election Day Presidential Exit Poll” screen presented by the survey/poll manager 101, according to certain embodiments of the present disclosure. In one embodiment, the “Election Day Presidential Exit Poll” screen 1200 may become user's home screen for a predefined number of days prior to national election day. For example, if the Election Day falls on November 8, the survey/poll manager 101 may make the “Election Day Presidential Exit Poll” screen 1200 user's home screen at midnight on November 6. It should be noted that the survey/poll manager 101 may be configured to broadcast messages to the plurality of users, prior to actual Election Day, about importance of voting. In various embodiments the broadcasted messages may comprise at least one of an email, a tweet, an SMS message, an MMS message, a USSD message or a smart TV app generated message. As shown in FIG. 12, the “Election Day Presidential Exit Poll” screen 1200 may include two or more buttons, such as “Vote” 1202 and “Share” 1204. According to an embodiment of the present invention, once the “Election Day Presidential Exit Poll” screen 1200 becomes user's home screen, the survey/poll manager 101 may lock the “Vote Counter” screen 900 and/or the “Projected Winner” screen 1100. In response to user pressing the “Vote” button 1202, the survey/poll manager 101 may allow the user to navigate to locked “Vote Counter” screen 900 and/or the “Projected Winner” screen 1100.

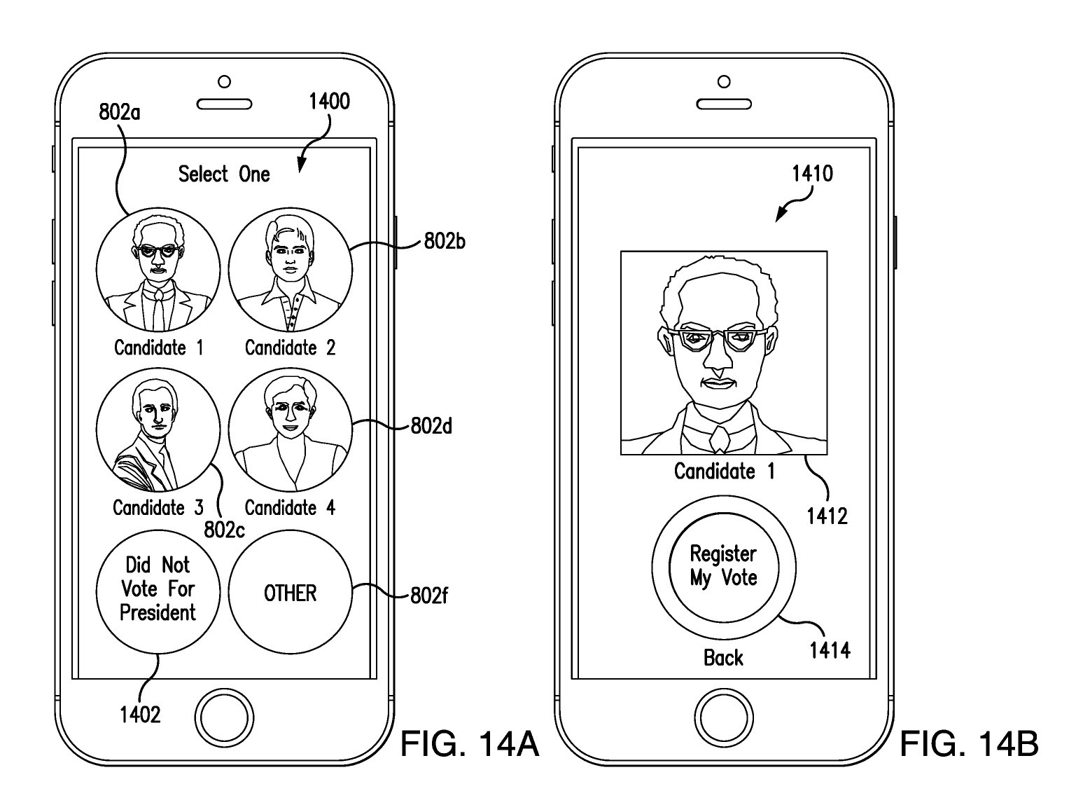

FIGS. 13, 14A-14B are exemplary presidential exit poll voting display screens presented by the survey/poll manager 101, according to certain embodiments of the present invention. The “Exit Poll Login” screen 1300 may become active on the morning of Election Day. For example, the “Exit Poll Login” screen 1300 may become active at 7 am Eastern Time on November 8. If this is not user's first visit, the survey/poll manager 101 may automatically retrieve information saved by the Remember Me feature 704 (see FIG. 7). According to an embodiment of the present invention, the retrieved information does not include precinct numbers. Thus, a user may be required to enter the precinct number in a corresponding field 1302 in order to get access to exit poll voting area.

According to an embodiment of the present invention, once users enter the precinct number in the field 1302 and select the “Go to Vote Screen” button 1304, the survey/poll manager 101 authenticates user's information and if the authentication information is valid, the “Election Day Voting” screen 1400 is presented next. The “Election Day Voting” screen 1400 may become activated at the same time the “Exit Poll Login” screen 1300 becomes active (i.e., the morning of the Election Day). The voting options 802a-802d and 802f presented by the “Election Day Voting” screen 1400 may be substantially identical to the voting options 802a-802d and 802f presented by the “Voting” screen” 800 (FIG. 8A) for the Weekly Straw Poll. However, in this case, the undecided category 802e presented by the “Voting” screen 800 may be replaced with “Did Not Vote For President” category 1402. According to an embodiment of the present invention, each user can vote only once in the Election Day exit poll. Accordingly, once the survey/poll manager 101 receives user's voting information, responsive to a user casting a vote, the survey/poll manager 101 removes user's access to the “Election Day Voting” screen 1400. Once user's access to the “Election Day Voting” screen 1400 is removed, an “Exit Poll Results” screen 1500 is presented to a user. Furthermore, for the remainder of the day, after logging in to the app, the “Exit Poll Results” screen 1500 becomes a home screen.

In response to receiving an interactive voter selection from the user's device, the survey/poll manager 101 presents a “Vote Registration” screen 1410 next (shown in FIG. 14B). According to an embodiment of the present invention, elements of the “Vote Registration” screen 1410 may include a bigger picture of the voter's selection 1412 and a touch button 1414. Responsive to user pressing the touch button 1414, the survey/poll manager 101 may tally the vote and may present the nationwide “Exit Poll Results” screen 1500 next. The survey/poll manager 101 may also generate a voting confirmation for the user/voter. In various embodiments the voting confirmation may comprise at least one of an email, a tweet, an SMS message, an MMS message, a Unstructured Supplementary Service Data (USSD) message or a smart TV app generated message. Text of the confirmation message may be similar to the confirmation message illustrated above in conjunction with FIG. 8A.

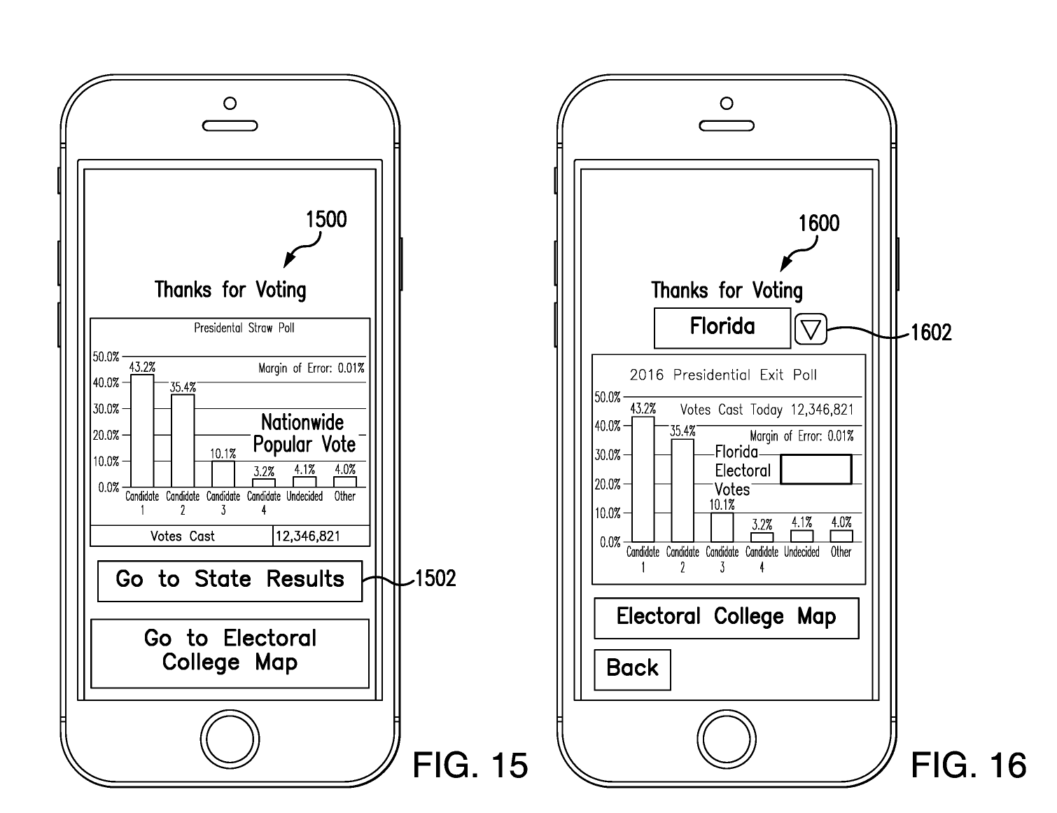

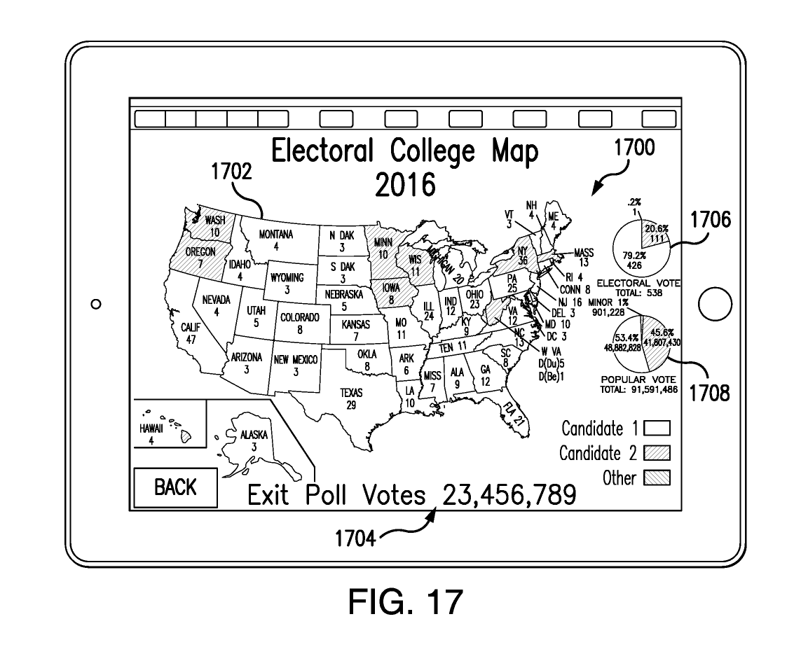

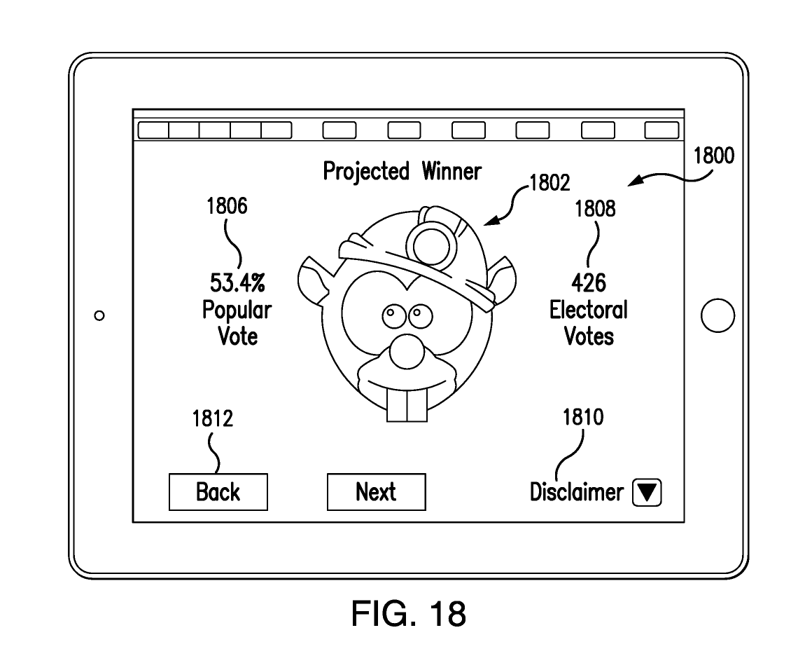

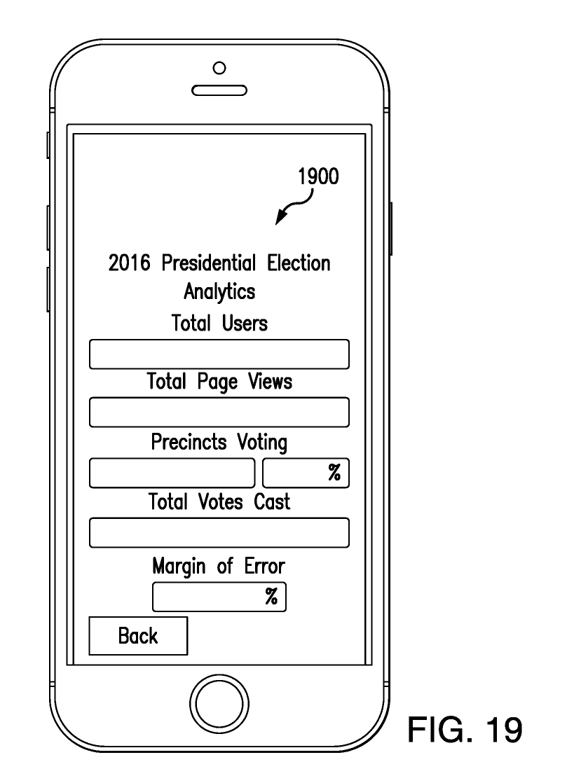

FIGS. 15-19 are exemplary presidential exit poll voting results screens presented by the survey/poll manager 101, according to certain embodiments of the present invention. FIG. 15 illustrates an exemplary nationwide “Exit Poll Results” screen 1500. The nationwide “Exit Poll Results” screen 1500 is operable to display Election Day popular vote results as tallied by the survey/poll manager 101. Advantageously, the survey/poll manager 101 presents the nationwide exit poll results in real time. As noted above, the nationwide “Exit Poll Results” screen 1500 becomes a home screen on the Election Day after users cast their votes. In one embodiment, the survey/poll manager 101 may lock the analysis and results presented by the “Exit Poll Results” screen 1500 approximately one hour after the final poll closes in last voting state (e.g., Hawaii). However, national polls mean very little due to the Electoral College election system of the U.S. According to an embodiment of the present invention, the nationwide “Exit Poll results” screen 1500 may include a “Go to State Results” touch button 1502.

According to an embodiment of the present invention, in response to user's selection of the “Go to State Results” touch button 1502, the survey/poll manager 101 presents a “Statewide Popular Vote Results” screen 1600 shown in FIG. 16. The “Statewide Popular Vote Results” screen 1600 is operable to display popular vote results for each state as tallied by the survey/poll manager 101. In one embodiment, the “Statewide Popular Vote Results” screen 1600 includes a drop-down menu 1602 which provides for an entry of the state. Thus, during the Election Day, the “Statewide Popular Vote Results” screen 1600 will provide users real time poll results on a state by state basis. According to an embodiment, the survey/poll manager 101 may be further configured to calculate and post Electoral College results after close of the polls in the corresponding state based on the analysis of the popular vote winner in that state performed by the survey/poll manager 101. This analysis performed after polls closings in each state enables the survey/poll manager 101 to generate a map presented by an “Electoral College Vote Results” screen 1700.

FIG. 17 shows an exemplary “Electoral College Vote Results” screen 1700 presented by the survey/poll manager 101, according to certain embodiments of the present disclosure. The survey/poll manager 101 posts projected Electoral College vote results for a state after close of polls in that state. In one embodiment, the “Electoral College Vote Results” screen 1700 may include a color-coded map of the United States 1702 and a real-time exit poll ticker 1704. In addition to color-coded information, the “Electoral College Vote Results” screen 1700 may include information in tabular tally form. The “Electoral College Vote Results” screen 1700 may also include graphical charts (e.g., pie charts) 1706 and 1708 representing real-time values of Electoral Vote and Popular vote tickers, respectively. As polls continue to close throughout the United States, the survey/poll manager 101 may continue to accumulate Electoral College vote results. In an embodiment, once 270 votes are reached, the survey/poll manager 101 may project the unofficial winner and present a “Projected Winner” screen 1800. It should be noted that even if the survey/poll manager 101 is ready to project a winner, the color-coded map 1702 continues to be updated until approximately one hour after the final poll closings in the last voting state (e.g., Hawaii).

FIG. 18 shows an exemplary “Projected Winner” screen 1800 presented by the survey/poll manager 101, according to certain embodiments of the present disclosure. When the survey/poll manager 101 determines that 270 Electoral Votes are achieved, the survey/poll manager 101 is ready to project the election winner and the “Projected Winner” screen 1800 becomes a home screen for all users. In one embodiment, the “Projected Winner” screen 1800 may include at least a picture 1802 of the projected winner and real-time results 1806 and 1808 of Popular Vote and Electoral Vote, respectively, conducted by the survey/poll manager 101. According to an embodiment of the present invention, the “Projected Winner” screen 1800 may include a “Disclaimer” drop-down menu option 1810. As a non-limiting example, the disclaimer may state that this is only a projection and is an unofficial result. Additionally, the disclaimer may encourage users to officially vote in their states, if they have not done so already. When a “Back” button 1812 is selected by users, the survey/poll manager 101 may take users back to the “Electoral College Vote Results” screen 1700.

FIG. 19 shows an exemplary “Analytics” screen 1900 presented by the survey/poll manager 101, according to certain embodiments of the present disclosure. According to an embodiment of the present invention, approximately one hour after the last vote is tallied in last voting state, the survey/poll manager 101 may lock the results screens 1500, 1600 and 1700 and may present the “Analytics” screen 1900 until the official winner is declared. The “Analytics” screen 1900 displays various analytics of the conducted Exit Poll that are maintained by the survey/poll manager 101. In one non-limiting example, such analytics may include total number of users, total number of page views, number of precincts voting, total number of casted votes, etc. The survey/poll manager 101 may also generate an official winner notification. In various embodiments, the winner notification may comprise at least one of an email, a tweet, an SMS message, an MMS message, a Unstructured Supplementary Service Data (USSD) message or a smart TV app generated message and may be sent to all users.

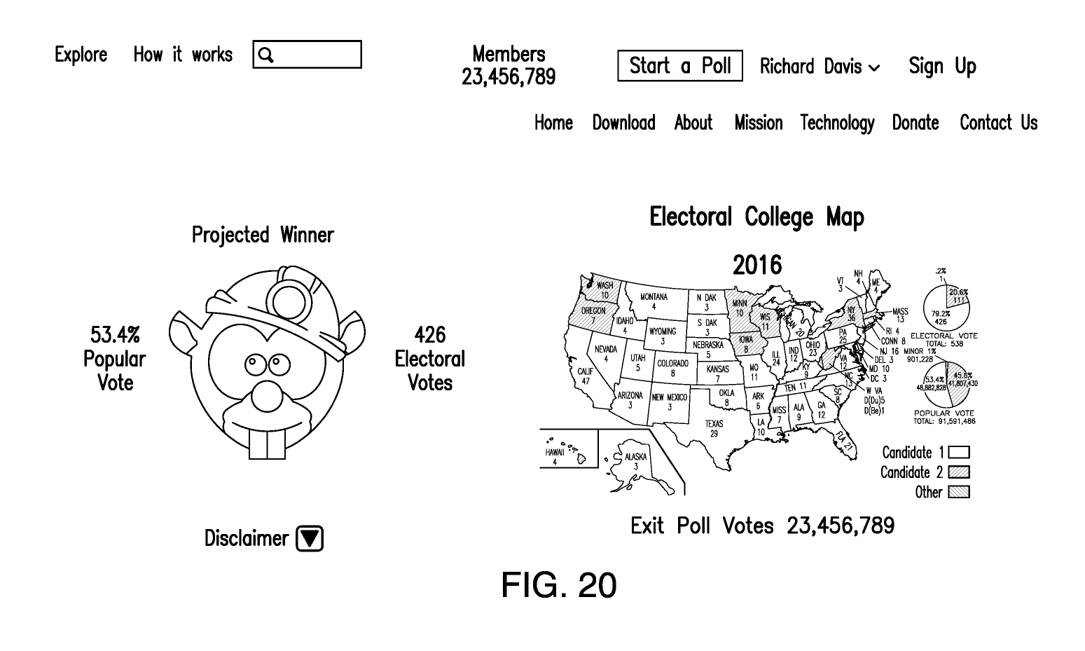

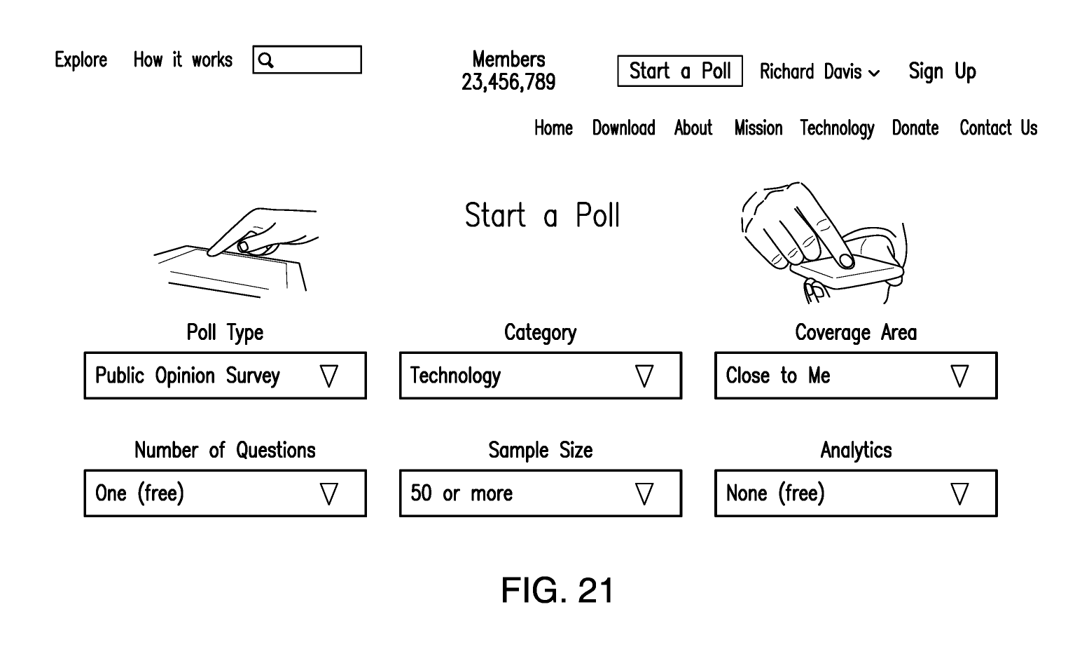

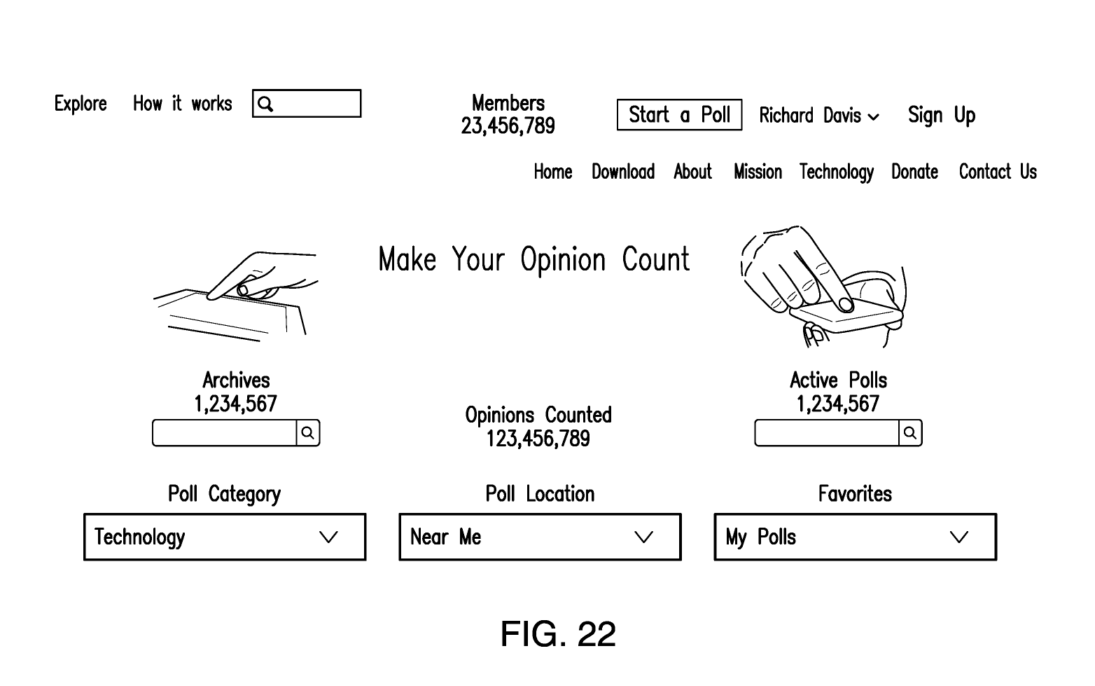

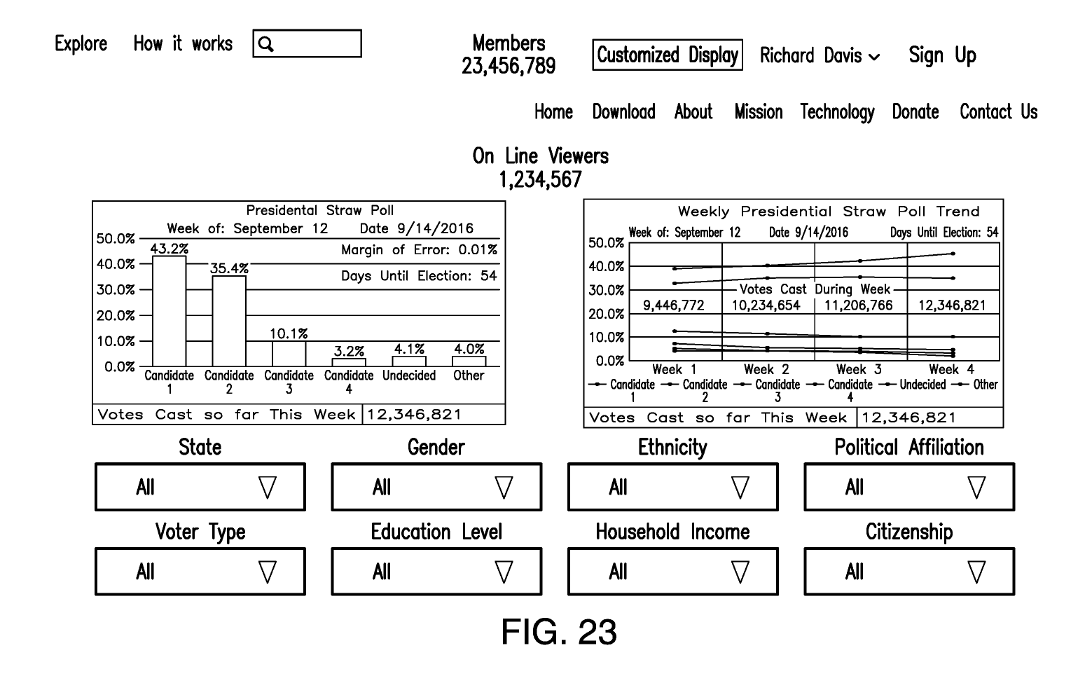

In various embodiments, the data processing platform 108 may be integrated with one or more web-sties. FIGS. 20-23 are an exemplary series of web-site integration display screens for displaying polling/survey data, according to certain embodiments of the present invention.

Therefore, embodiments of the present invention are directed to an application for a mobile device operatively interconnected with a cloud-based data processing platform. The application and data processing platform include a computer program embedded on, e.g., a non-transitory, tangible medium. The computer program running on the mobile device includes at least computer readable code for establishing a two-way data transmission connection between the mobile device and the data processing platform. The computer program running on the data processing platform includes at least computer readable code for: i) storing authorized user information; ii) displaying on the mobile device a voting option for an authorized user, iii) analyzing votes from a plurality of authorized users, iv) enabling the display on the mobile device of a statistical analysis of the votes of the plurality of authorized users, v) providing information pertaining to the authorized user, vi) a combination thereof. Advantageously, the system for automated online polling and voting disclosed herein is configured to technologically enable automatic querying (i.e., polling) of an unlimited audience of users in real time in order to canvas enormous sample sizes of responders, thus significantly reducing polling margins of error.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method for conducting a survey or poll, comprising steps of:
receiving authentication data from a plurality of users;
evaluating the received authentication data to determine if the authentication data is valid for each user;
providing the user access to a plurality of voting options, in response to determining that the authentication data is valid for that user;
receiving from at least some of the plurality of users voting information identifying selected one of the plurality of voting options;
analyzing the received voting information in real time; and
presenting to at least some of the plurality of users voting results based on the analyzed voting information.

2. The method of claim 1, wherein the authentication data includes at least one of user name, password, user device information or a combination thereof.

3. The method of claim 1, wherein received data is analyzed and stored by a cloud-based analytics platform.

4. The method of claim 3, further comprising encrypting the received voting information prior to storing it.

5. The method of claim 1, wherein the plurality of voting options is related to at least one of a political poll, a market research survey, a public opinion poll, and the like.

6. The method of claim 1, wherein the step of providing the user access to the plurality of voting options comprises providing the user access to a first plurality of voting options prior to a predefined election day and providing the user access to a second plurality of voting options on the predefined election day.

7. The method of claim 1, wherein the step of presenting the voting results based on the analyzed voting information further comprises presenting a graphical representation of the analyzed voting information as a two-dimensional diagram.

8. The method of claim 1, wherein the step of receiving from at least some of the plurality of users voting information further comprises performing load-balancing of received voting information across a plurality of web servers.

9. The method of claim 2, wherein the user device information comprises at least one of: wireless service provider identification, device model identification, device identification, international mobile equipment identity (IMEI), integrated circuit card identifier (ICCID).

10. A computer system comprising:
a cloud-based analytics platform having
a non-transitory memory device for storing computer readable program code; and
at least one processor in communication with the memory device, the processor being operative with the computer readable program code to:
receive authentication data from a plurality of users;
evaluate the received authentication data to determine if the authentication data is valid for each user;
provide the user access to a plurality of voting options, in response to determining that the authentication data is valid for that user;
receive from at least some of the plurality of users voting information identifying selected one of the plurality of voting options;
analyze the received voting information in real time; and
present to at least some of the plurality of users voting results based on the analyzed voting information.

11. The computer system of claim 10, wherein the authentication data includes at least one of user name, password, user device information or a combination thereof.

12. The computer system of claim 10, wherein the processor is further being operative with the computer readable program code to encrypt the received voting information prior to storing it.

13. The computer system of claim 10, wherein the plurality of voting options is related to at least one of a political poll, a market research survey, a public opinion poll, and the like.

14. The computer system of claim 10, wherein the processor being operative with the computer readable program code to provide the user access to the plurality of voting options is further being operative with the computer readable program code to provide the user access to a first plurality of voting options prior to a predefined election day and provide the user access to a second plurality of voting options on the predefined election day.

15. The computer system of claim 10, wherein the processor being operative with the computer readable program code to present the voting results based on the analyzed voting information is further being operative with the computer readable program code to present a graphical representation of the analyzed voting information as a two-dimensional diagram.

16. The computer system of claim 10, wherein the processor being operative with the computer readable program code to receive from at least some of the plurality of users voting information is further being operative with the computer readable program code to perform load-balancing of received voting information across a plurality of web servers.

17. The computer system of claim 11, wherein the user device information comprises at least one of: wireless service provider identification, device model identification, device identification, international mobile equipment identity (IMEI), integrated circuit card identifier (ICCID).

18. One or more non-transitory computer-readable storage media, having computer-executable instructions embodied thereon, wherein when executed by at least one processor, the computer-executable instructions cause the processor to:
receive authentication data from a plurality of users;
evaluate the received authentication data to determine if the authentication data is valid for each user;
provide the user access to a plurality of voting options, in response to determining that the authentication data is valid for that user;
receive from at least some of the plurality of users voting information identifying selected one of the plurality of voting options;
analyze the received voting information in real time; and
present to at least some of the plurality of users voting results based on the analyzed voting information.

19. The non-transitory computer-readable storage media of claim 18, wherein the authentication data includes at least one of user name, password, user device information or a combination thereof.

20. The non-transitory computer-readable storage media of claim 19, wherein the user device information comprises at least one of: wireless service provider identification, device model identification, device identification, international mobile equipment identity (IMEI), integrated circuit card identifier (ICCID).
